(19) United States
(12) Patent Application Publication
(10) Pub. No.: US 2025/0235918 A1
(43) Pub. Date: Jul. 24, 2025

(54) SUPERSONIC FLUIDIC OSCILLATOR AND METHOD OF CONTROLLING A SUPERPLASTIC FORMING PROCESS

(71) Applicant: AEM POWER SYSTEMS INC., Windsor (CA)

(72) Inventor: Eugene Ryzer, Windsor (CA)

(21) Appl. No.: 18/698,185

(22) PCT Filed: Jun. 30, 2023
(86) PCT No.: PCT/CA2023/050898

§ 371 Date: Apr. 3, 2024

Related U.S. Application Data
(60) Provisional application No. 63/358,709, filed on Jul. 6, 2022.

(51) Int. Cl. B21D 26/055

(52) U.S. Cl. CPC B21D 26/055

(57) ABSTRACT

A method of controlling superplastic forming where a sheet of material is subjected to superplastic forming when in a chamber of a forming apparatus having a supersonic fluidic oscillator (SFO) includes determining maximum and minimum limits for a ratio of supply pressure applied to the SFO related to forming pressure, where the application of supply pressure to the SFO in a manner that maintains the ratio between the maximum and minimum limit causes the SFO to generate continuous, uninterrupted, gas oscillations; with a supply pressure sensor, detecting the gas pressure supplied to the SFO and transmitting it to a controller; with a forming pressure sensor, detecting the forming pressure within the chamber and transmitting it to the controller; and operating the controller to maintain the pressure supplied to the SFO to maintain the ratio of the detected supply pressure to the detected forming pressure between the maximum and minimum limits.

### CROSS-REFERENCE TO RELATED APPLICATION(S)

This application is a Section 371 National Stage Application of International Application No. PCT/CA2023/050898, filed Jun. 30, 2023 and published as WO 2024/007073 A1 on Jan. 11, 2024, in English, and claims priority to U.S. provisional patent application Ser. No. 63/358,709, filed Jul. 6, 2022.

### FIELD OF INVENTION

This invention relates in general to the field of superplastic forming, and in an embodiment to a supersonic fluidic oscillator (SFO) for use in superplastic blow forming and the control of a superplastic blow forming process.

### BACKGROUND

A superplastic forming process, such as superplastic blow forming, can be used to create a wide variety of different products, including many parts or components used in the automotive and aerospace industries. Typically, superplastic blow forming is accomplished by clamping a metallic alloy sheet (which is often in the form of a relatively thin sheet) within a sealed and heated forming tool, heating the sheet to a point of superplasticity (where material is heated to temperature higher than one half of its melting point), and then introducing pressurized gas to one side of the metallic sheet (forming material) to force it “elongate” or “stretch” or “flow”, and to take the shape of the forming tool surface. The gas pressure applied to the forming material forcing it to stretch or flow is generally referred to as the gas forming pressure P_{forming} (ie. gas pressure inside the blow forming tool pressurized chamber). In the automotive industry, magnesium alloy (for example AZ31B) and aluminum alloy (for example, AA5083) single sheets may be heated and superplastically blow formed in a temperature range of 400 to 500 degrees Celsius to create body panels such as doors, fenders, bodysides, lift gates, roofs, and other such parts. In the aerospace industry, titanium alloy sheets can be heated and superplastically blow formed as single sheets in the temperature range of 700 to 900 degrees Celsius into various geometrically complex aerospace panels. Multi sheet forming may also occur, where superplastic forming is combined with diffusion bonding to create intimate contact between two materials at high temperature and relatively low pressure, and to then form and bond multiple sheets together in an inert gas environment. Multi sheet forming can offer additional process benefits, including high stiffness attained through multi-sheet structures such as honeycomb components.

Currently, superplastic blow forming processes are relatively slow forming processes, primarily due to the inability of the forming material to achieve a high degree of elongation at high strain rates without developing tears or cracks. A complex automotive part, for instance, formed from an aluminum or magnesium alloy sheet using a conventional superplastic blow forming process can require as much as from 3 to 30 minutes to manufacture. Similarly, a complex aerospace component, formed from a titanium alloy sheet through conventional superplastic blow forming can require as much as 45 minutes to 10 hours to manufacture. As a result, the use of typical superplastic forming processes is often limited to producing high value parts, or parts for high valued applications.

There is therefore a need for a higher strain rate, superplastic blow forming process with higher elongation to allow for improved production speeds and/or that allow for improved elongation rates resulting in more complex geometrically produced products.

### SUMMARY

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of examples, to the accompanying drawings which show exemplary embodiments of the present invention in which:

FIG. 1 is a schematic view of an exemplary bi-stable load switched supersonic fluidic oscillator having two exhaust ports.

FIGS. 2, 3, 4A, 4B, 4C and 4D are successive schematic views of an embodiment of a superplastic forming assembly during a superplastic flow forming cycle, demonstrating the principal stages for forming a single part in a blow forming tool.

FIGS. 5, 6, 7A and 7B, are successive schematic views of an alternative embodiment of a superplastic forming assembly during a superplastic blow forming cycle, demonstrating the principal stages for forming two parts in a blow forming tool.

FIG. 8 is a graph showing an exemplary baseline pressure curve of the gas inside a pressurized chamber of a blow forming tool during a typical superplastic blow forming cycle.

FIGS. 9A, 9B, and 9C are non-scale representations of pressure-time curves, each generally depicting an example relationship between a baseline gas pressure and a fluctuating gas forming pressure inside one pressurized chamber of a blow forming tool, wherein FIG. 9A represents a slow filling time, FIG. 9B represents a medium filling time, and FIG. 9C represents a fast filling time.

FIGS. 10A and 10B are schematic views of an exemplary bi-stable load switched supersonic fluidic oscillator, with two exhaust ports pointing inward (as may be the case when the forming tool contains one forming chamber), demonstrating flow switching from one output flow channel to the other.

FIGS. 11A and 11B are schematic views of an exemplary bi-stable load switched supersonic fluidic oscillator, with two exhaust ports pointing outward (as would typically be the case when the forming tool contains two formation chambers), demonstrating flow switching from one output flow channel to the other.

FIGS. 12A and 12B are schematic views of an exemplary bi-stable load switched supersonic fluidic oscillator, with two exhaust ports pointing inward and connected to a single pressurized forming chamber, showing flow switching from one output flow channel to the other.

FIGS. 13A and 13B are schematic views of an exemplary bi-stable load switched supersonic fluidic oscillator, with two exhaust ports pointing inward and connected to two separate pressurized forming chambers.

FIGS. 14A and 14B are schematic views of an exemplary bi-stable load switched supersonic fluidic oscillator, with two exhaust ports pointing outward and connected to two separate pressurized forming chambers.

FIG. 15 is a graph showing a relationship between gas pressure in the pressurized chamber of a blow forming tool and gas supply pressure entering a bi-stable load switched supersonic fluidic oscillator, illustrating a maximum and a minimum ratio of those pressures, between which the SFO generates continuous, uninterrupted, gas oscillations.

FIG. 16 is a schematic view of an embodiment of a single chamber blow forming tool having a bi-stable load switched supersonic fluidic oscillator, gas pressure sensors, and a gas pressure controller 30, demonstrating forming a component through superplastic blow forming.

FIG. 17 is an enlarged detail view of portion “A” of FIG. 16.

FIG. 18 is a schematic view of an embodiment of a dual chamber blow forming tool having a bi-stable load switched supersonic fluidic, gas pressure sensors, and a gas pressure controller, demonstrating forming two components through a superplastic blow forming.

FIG. 19 is an enlarged detail view of portion “B” of FIG. 18.

FIG. 20 is a schematic view of an embodiment of a single chamber blow forming tool having a bi-stable load switched supersonic fluidic oscillator, gas pressure sensors, and a gas pressure controller 30, demonstrating forming a single part, wherein the bi-stable load switched supersonic fluidic oscillator is machined into a pressing surface of the blow forming tool.

FIG. 21 is an enlarged detail view of portion “C” of FIG. 20

FIG. 22 is an enlarged detail view of portion “D” of FIG. 18, portion “D” being oriented 90 degrees to portion “B”.

FIG. 23 is a schematic plan view of a portion of the lower surface of the chamber portion of a blow forming tool, wherein the lower surface has been machined to form part of a bi-stable load switched supersonic fluidic oscillator therein, the lower defining surface of the bi-stable load switch supersonic fluidic oscillator being formed by the upper face of the sheet of material clamped between the chamber portion and the tool portion of the blow forming tool.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DESCRIPTION

The present invention may be embodied in a number of different forms. The specification and drawings that follow describe and disclose some of the specific forms of the invention.

In the field of fluid dynamics, an emerging topic of interest is the study of fluidic diverter actuators for flow control. Two papers describing such research were published by NASA in 2010 and 2011, and are entitled “Numerical Studies of a Supersonic Fluidic Diverter Actuator for Flow Control” (Gokoglu, S., Kuczmarski, M., Culley, D., and Raghu, S., “Numerical Studies of a Supersonic Fluidic Diverter Actuator for Flow Control,” Presented at the 5th Flow Control Conference 2010, Chicago, Illinois, USA, Jun. 28-1 Jul. 2010) and “Numerical Studies of an Array of Fluidic Diverter Actuators for Flow Control” (Gokoglu, S., Kuczmarski, M., Culley, D., and Raghu, S., “Numerical Studies of an Array of Fluidic Diverter Actuators for Flow Control,” Presented at the 41st Fluid Dynamics Conference and Exhibit sponsored by the American Institute of Aeronautics and Astronautics, Honolulu, Hawaii, USA, Jun. 27-30, 2011). The papers describe the oscillatory behavior of flows through fluidic diverter actuators, also known as fluidic oscillators. Under some operating conditions such oscillators are known as supersonic fluidic oscillators. Recently, fluidic devices utilizing gasses as the working fluid, have found application at the micro-level in drug administration and lab-on-a-chip devices (Jayamohan, H., Sant, J., H., Gale, K., B., “Application of Microfluidics for Molecular Diagnostics,” Microfluidic Diagnostics, P305-334, Human Press, Totowa, NJ, USA, 2013).

Bi-stable supersonic fluidic oscillators are one form of fluidic device which provide oscillatory flow outputs for steady flow inputs. The oscillator makes use of a jet flow that attaches to one of two sidewalls as a result of a phenomenon known as the Coanda Effect. Any of several types of flow switching mechanisms may be used to switch the jet flow between the two sidewalls. That is, bi-stable supersonic fluidic oscillators require a switching mechanism to move the flow from the attached channel side to the opposite channel, and back, repeating continuously. Typically one or more of three types of switching mechanisms are used. Those switching mechanisms comprise (i) momentum switching (ii) pressure (recirculation) switching and (iii) load switching. Recently, a research paper describing a method to estimate the operation of a bi-stable supersonic fluidic oscillator with internal flows to predict its performance for industrial design purposes was published by Xu in 2022 (Xu, S., Ryzer, E., and Rankin, G. W., 2022, “A Robust Pseudo-Three-Dimensional Computational Fluid Dynamics Approach for Industrial Applications,” J. Fluids Eng., 144(9)). That research provides industrial designers with a tool for improving the accuracy of bi-stable supersonic fluidic oscillator computational fluid dynamics simulations. In another research publication by Xu entitled, “Comparison of Hybrid Multi-Dimensional Numerical Models of a Bi-Stable Load-Switched Supersonic Fluidic Oscillator Application” (Sidhu, L., Peirone, C., Xu, S., Rankin, G., 2019, “Comparison of a hybrid multidimensional numerical models of a bi-stable load-switched supersonic fluidic oscillator,” 14th International Conference of Heat Transfer, Fluid Mechanics and Thermodynamics (HEFAT 2019), Wicklow, Ireland), a numerical investigation of a bi-stable load-switched supersonic fluidic oscillator was performed to understand the performance of the device under variety of operating conditions. In another research publication by Xu entitled, “Experimental Investigation of a Bi-Stable Supersonic Fluidic Oscillator” (Xu, S., 2018, “Experimental Investigation of a Bi-Stable Supersonic Fluidic Oscillator,” M.A.Sc. Thesis, Mechanical Engineering, University of Windsor (Ontario, Canada)), experimental investigation was performed on one geometrical configuration of a bi-stable supersonic fluidic oscillator over a range of supply pressure, control channel flow resistance and exhaust chamber pressure values for the purposes of determining their effect on the device oscillation frequency and amplitude. In a further research publication by Xu entitled, “An experimental and Numerical Investigation of a Bistable Load-Type Supersonic Fluidic Oscillator” (Xu, S., Ryzer, E., and Rankin, G. W., 2022, “An Experimental and Numerical Investigation of a Bistable Load-Type Supersonic Fluidic Oscillator,” J. Fluids Eng. (recently submitted and should be published later this year)), fluid dynamic mechanisms involved in the operation of a bi-stable supersonic fluidic oscillator are investigated over an extensive range of operating conditions to explain the performance of the device.

A bi-stable load switched supersonic fluidic oscillator relies on a load switching mechanism to divert flow utilizing feedback tanks. As the flow travels through narrow flow channels, the feedback tanks fill, which results in an increase in pressure that propagates upstream towards the jet exit. When the pressure at a splitter tip reaches a sufficiently high value, the jet switches to the other channel. This process then repeats itself using a second feedback tank, causing oscillation.

R. V. Thompson et al. (Thompson, R., 1970, “Supersonic Fluidics Empirical Design Data,” Proceedings of the Fourth Cranfield Fluidics Conference, Coventry, UK, pp. N2-17 to N2-44) conducted an extensive study of the effects of geometry on the performance of bi-stable load switched supersonic fluidic oscillators. Thomas investigated the splitter angle, control channel width, control channel location, main channel length, and the position of the splitter in relation to the throat location.

Hiroki et al. (Hiroki, F., Yamamoto, K., and Nasuda, T., 1993, “Fluidic Oscillator Using a Supersonic Bistable Device and Its Oscillation Frequency,” J. Fluid Control, 21(4), pp. 28-47) adopted the design criteria developed by R. V. Thompson et al. (Thompson, R., 1970, “Supersonic Fluidics Empirical Data,” Proceedings of the Fourth Cranfield Fluidics Conference, Coventry, UK, pp. N2-17 to N2-44) and conducted both analytical and experimental investigations of the oscillation frequencies from a bi-stable load switched supersonic fluidic oscillator for the application of material fatigue testing.

Each of the above-mentioned references are incorporated herein, in their entirety, by reference.

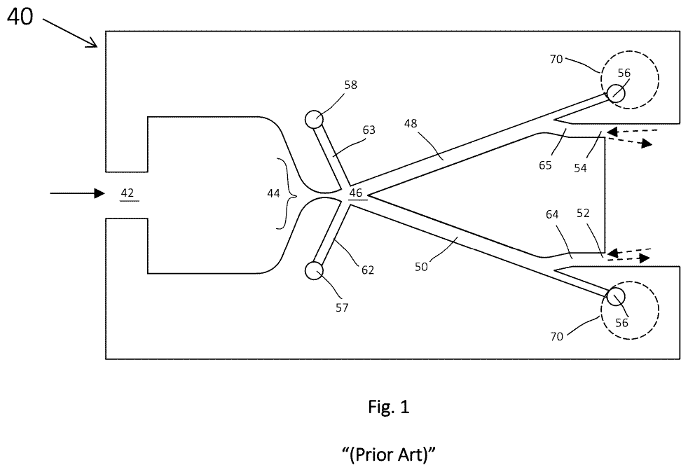

To provide a better understanding of how a bi-stable load switched supersonic fluidic oscillator works, a schematic of an exemplary bi-stable load switched supersonic fluidic oscillator 40 has been provided as FIG. 1. Fluid enters supersonic fluidic oscillator 40 through a bi-stable load switched supersonic fluidic oscillator inlet 42 as shown by the solid arrow. The jet of fluid (not shown) created at the end of a converging section 44 has a supersonic exit velocity at a diverging nozzle and diverts alternately, or oscillates, at a splitter or fork 46 between output flow channels 48 and 50 due to alternating back pressure in a pair of feedback tanks 70 (not specifically shown) that are attached to output flow channels 48 and 50 at ports 56. The gas exits bi-stable load switching supersonic fluidic oscillator 40 through exhaust flow channels 64 and 65 at exhaust flow ports 52 and 54 at particular frequencies and amplitudes of oscillation, with the flow “oscillating” between channels 64 and 65. Control channels 62 and 63 provide an auxiliary flow mechanism to help with the stability of the gas jet flow reattachment after load switching to one of the output flow channels 48 or 50 in the expansion region close to splitter 46. Control channels 62 and 63 are connected via control flow channel ports 57 and 58, respectively, to sealed chamber 24 into which gas exiting exhaust flow ports 52 and 54 is received.

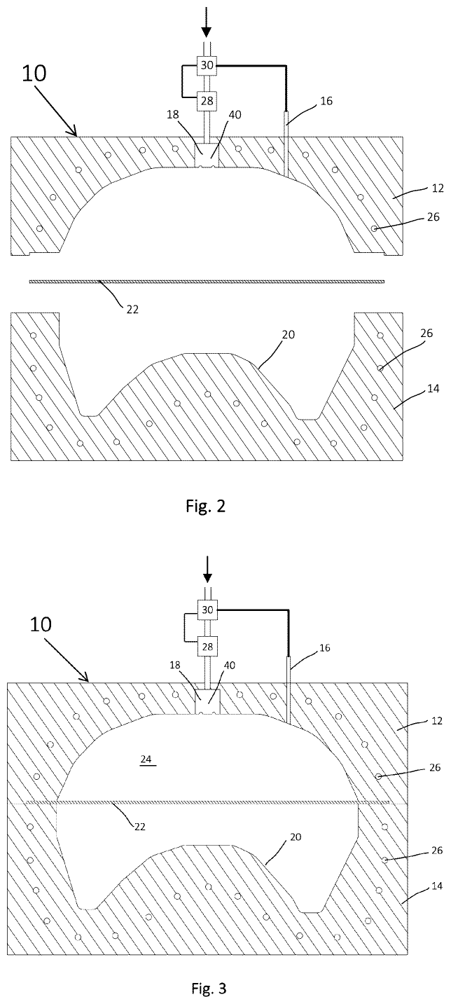

FIGS. 2, 3, 4A, 4B, 4C and 4D show an embodiment of a superplastic blow forming apparatus 10 for forming a single part. Apparatus 10 is generally comprised of a chamber portion (upper) 12 and a tool portion (lower) 14, which together form opposed tool portions that are clamped or pressed together with a sheet of material 22, which is to be formed into a desired part or article, positioned therebetween. Chamber portion 12 includes a gas forming pressure sensor 16 and a bi-stable load switched supersonic fluidic oscillator 40. An injection or supply pressure sensor 28, for detecting the gas pressure that is directed into bi-stable load switched supersonic fluidic oscillator 40, resides in the gas flow inlet channel 42, or resides in a gas pressure controller 30. Pressure controller 30 is coupled upstream to injection pressure sensor 28 and to gas pressure sensor 16. Tool portion 14 includes a tool forming surface 20. When chamber and tool portions 12 and 14 are clamped together, a sealed chamber 24 is formed.

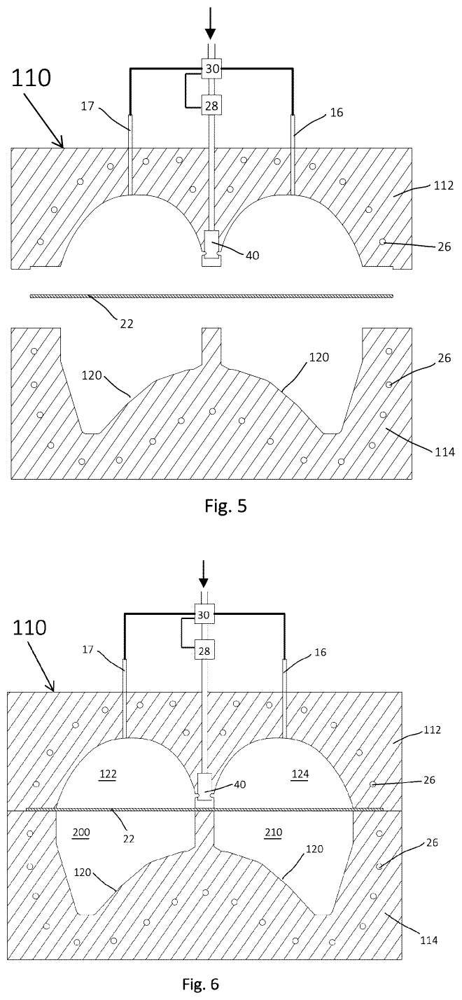

FIGS. 5, 6, 7A and 7B, show an alternative embodiment of superplastic blow forming apparatus 10 (in this embodiment referenced as 110) for forming two separate parts. Apparatus 110 is generally comprised of a chamber portion (upper) 112 and a tool portion (lower) 114. Chamber portion 112 includes a pair of gas forming pressure sensors 16 and 17 and bi-stable load switched supersonic fluidic oscillator 40. As in the case of the embodiment of FIGS. 2 through 4D, an injection pressure sensor 28 detects the gas pressure that is directed into bi-stable load switched supersonic fluidic oscillator 40. A pressure controller 30 is also coupled upstream of injection pressure sensor 28 and gas pressure sensors 16 and 17. Tool portion 114 includes a pair of blow forming tool forming surfaces 120. When chamber and tool portions 112 and 114 are clamped together, a pair of sealed chambers 122, 124 and a pair of unsealed chambers 200, 210 are formed (see, for example, FIG. 6). In the depicted embodiment, one gas pressure sensor 16, 17 is situated in each of sealed chambers 122, 124 and oscillator 40 is in fluid communication with each sealed chamber 122, 124. As shown in the particular embodiment depicted in FIG. 6, the sizes and shapes of sealed chambers 122, 124 are essentially identical, and can be of mirror images of each other about bi-stable load switched supersonic fluidic oscillator 40. Unsealed chambers 200, 210 are also essentially identical in size and shape.

At the beginning of a typical superplastic blow forming process, sheet of material 22 is placed between chamber portion 12 and tool portion 14, or between chamber portion 112 and tool portion 114, as shown in FIGS. 2 and 5. In the depicted embodiments material 22, (which could commonly be an aluminum, magnesium, or titanium alloy), is in the form of a sheet that is relatively thin when compared to its length and width. Other forms and types of material 22 could be used in alternate embodiments. Chamber and tool portions 12/112 and 14/114 are clamped together (as shown in FIGS. 3 and 6), securing material 22 in place and forming sealed chambers 24 and 122, 124. Material 22 is then heated to a predetermined forming temperature, placing material 22 generally in a state of superplasticity. Heating the material may be achieved through the use of embedded electrical resistance elements 26 within heating chamber and tool portions 12/112 and 14/114, however, it will be appreciated that other heating means, including a heating oven, could be utilized.

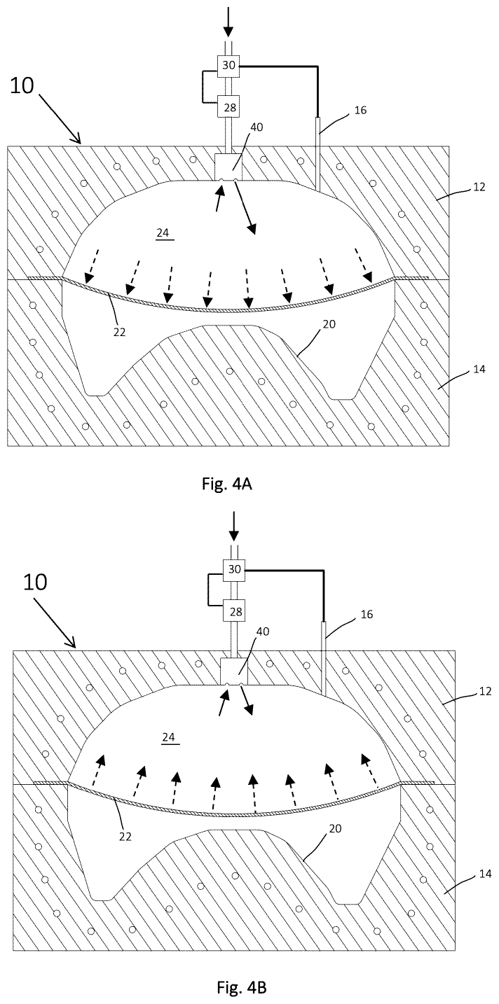

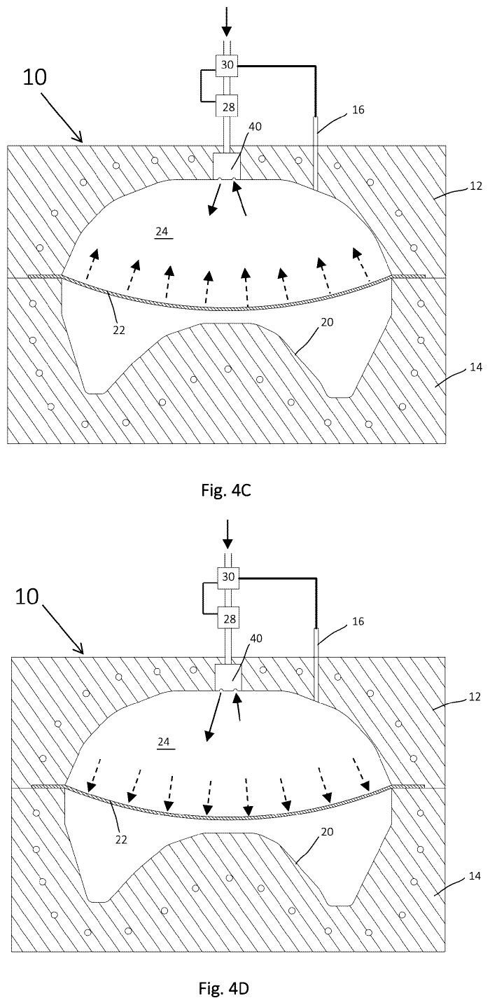

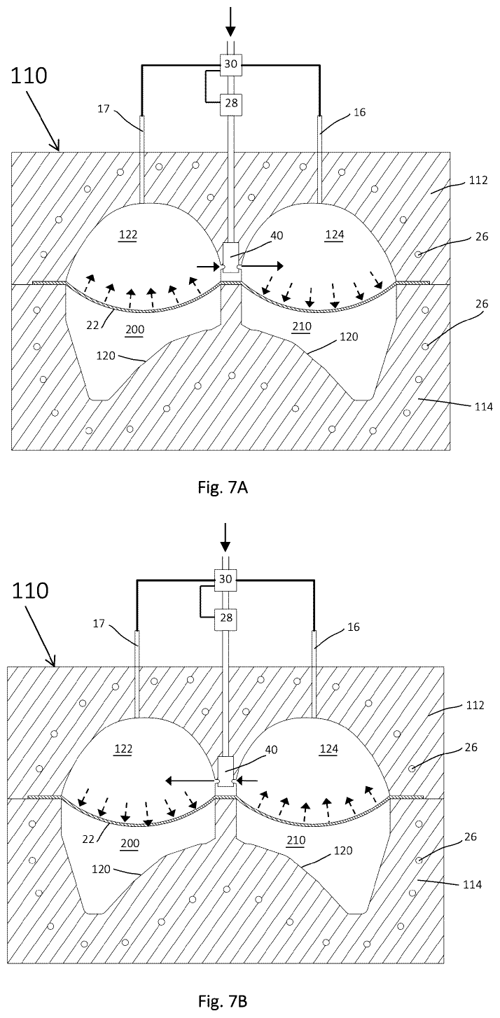

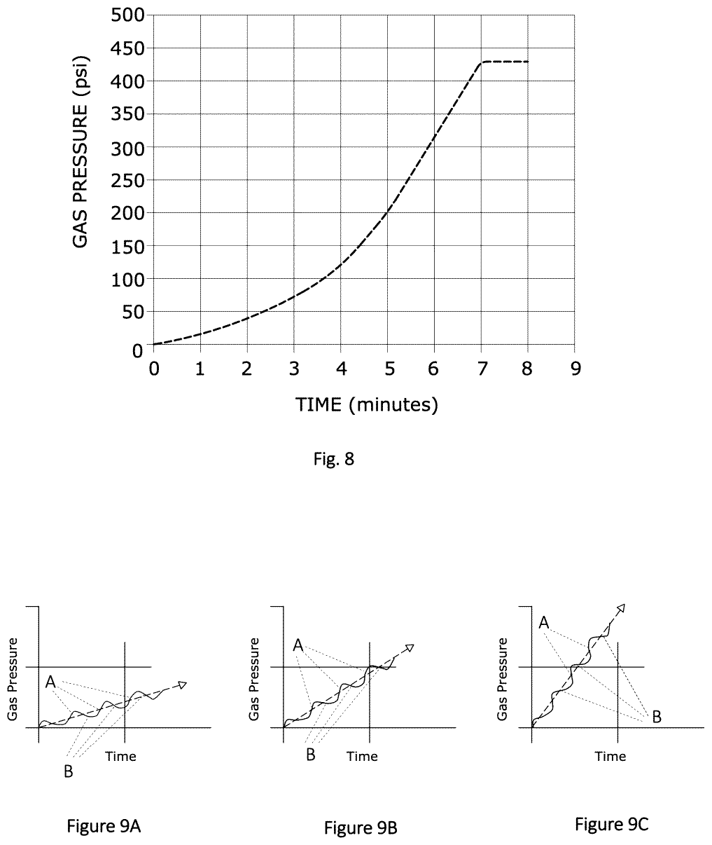

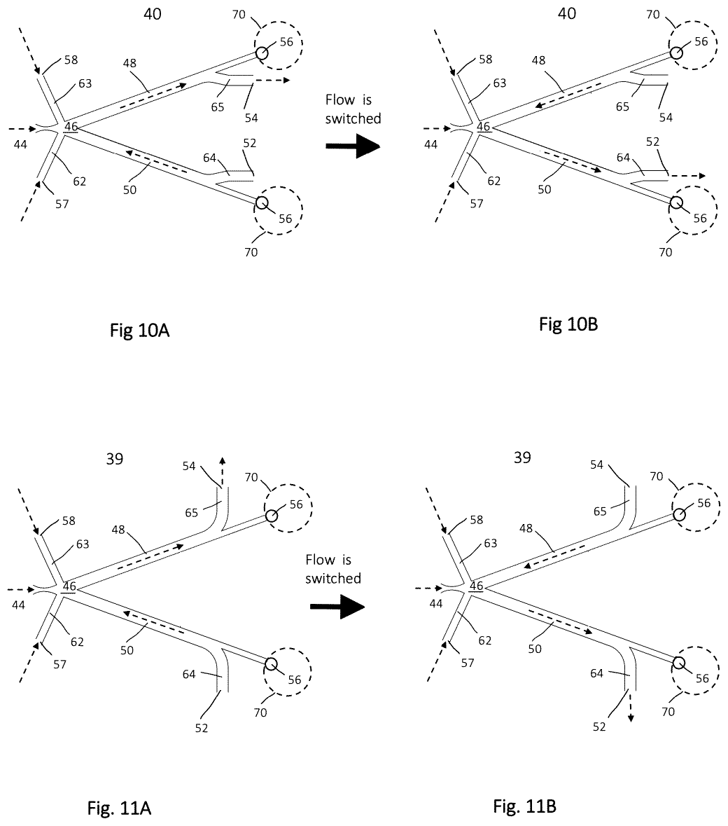

As shown in FIGS. 4A, 4B, 4C, 4D, 7A, and 7B, pressurized gas (noted by the solid arrow) may be introduced into sealed chamber 24, or sealed chambers 122, 124, via oscillator 40. The pressurized gas establishes a baseline pressure within sealed chambers 24 and 122, 124. Pressure sensor 16 measures the gas pressure within sealed chamber 24 (and pressure sensors 16, 17 measure the gas pressure within sealed chambers 122, 124) during the blow forming process. In order to maintain a desired pressure/time curve or relationship during the blow forming process, and to maintain the desired gas fluctuations or oscillations, a feedback mechanism is formed whereby pressure controller 30 monitors the pressure within the chambers via pressure sensor(s) 16, 17 and, in conjunction with injection pressure sensor 28, controls or regulates the amount (or pressure) of gas supplied to the bi-stable load switched supersonic fluidic oscillator 40, and how much gas is injected into the sealed chambers 24 and 122, 124 by gas oscillator 40.

As shown in the depicted embodiments, the pressure controller may be separate from oscillator 40 and may be outside forming apparatus 10/110. Injection gas pressure sensor 28, while shown to be outside the forming apparatus, may alternatively be located within forming apparatus 10/110, so long as injection pressure sensor 28 is downstream from pressure controller 30 and upstream from bi-stable load switched supersonic fluidic oscillator 40.

In the case of superplastic blow forming apparatus 10, as bi-stable load switched supersonic fluidic oscillator 40 injects gas into sealed chamber 24 to create and maintain a desired baseline pressure, the SFO also injects holds, and withdraws small amounts of gas into and out of sealed chamber 24 as shown by the solid arrows in FIGS. 4A, 4B, 4C, and 4D, thereby generating pressure fluctuations. The pressure fluctuations applied by bi-stable load switched supersonic fluidic oscillator 40 cause the actual or overall gas pressure within sealed chamber 24 to fluctuate or oscillate relative to the baseline pressure. Any gas that is withdrawn from sealed chamber 24 by bi-stable load switched supersonic fluidic oscillator 40, as noted above, tends to be minute in comparison to the gas that is injected into the sealed chamber by bi-stable load switched supersonic fluidic oscillator 40.

Similarly, in the case of superplastic blow forming apparatus 110, as bi-stable load switched supersonic fluidic oscillator 40 injects gas into sealed chambers 122, 124 to create and maintain a baseline pressure, bi-stable load switched supersonic fluidic oscillator 40 also injects, holds, and withdraws small amounts of gas into and out of one sealed chamber (for example sealed chamber 122), while inversely withdrawing and injecting small amounts of gas into and out of the other sealed chamber (for example 124). In this manner, the fluctuating pressure applied by bi-stable load switched supersonic fluidic oscillator 40 causes the actual or overall gas pressure within sealed chambers 122 and 124 to inversely fluctuate, albeit slightly, relative to the baseline pressure. Any gas that is withdrawn from the sealed chambers by bi-stable load switched supersonic fluidic oscillator 40, tends to be minute in comparison to the gas that is injected into the sealed chambers by bi-stable load switched supersonic fluidic oscillator 40.

The forming gas pressure according to the present invention is thus a combination of the baseline gas pressure and the fluctuating gas pressure. The fluctuating gas pressure may be positive, close to neutral, or in some circumstances negative relative to the baseline pressure. FIGS. 9A, 9B, and 9C are non-scale graphical representations of gas pressure vs time curves, each depicting a relationship between the baseline gas pressure and the forming gas pressure which exists, in one sealed chamber. In all three Figures, the baseline pressure is indicated by a dashed line that begins at the x-y axis junction. The forming or actual gas pressure is depicted by a solid line. As shown, the forming pressure fluctuates back and forth between values above, close to equal, and in certain instances below, the baseline pressure in accordance with the operation of gas oscillator 40. Typically, if the forming pressure dips below the baseline pressure during the forming process, the pressure drop tends to be minute. FIG. 9A shows the baseline gas pressure and forming gas pressure for a relatively slow filling time. FIG. 9B shows the baseline gas pressure and forming gas pressure for a medium filling time. FIG. 9C shows the baseline gas pressure and forming gas pressure for a faster filling time.

As shown in FIGS. 9A through 9C, when gas is injected into sealed chambers 24, 122, or 124, the slope (i.e. rate of change) of the forming gas pressure is higher, as indicated by “pressure inclines” noted by reference character A. When the pressure in sealed chambers 24, 122, or 124 is “held” relatively constant, the slope (i.e. rate of change) of the forming pressure is small, zero, or possibly negative, as indicated by “pressure holds” noted by reference character B. In this manner, the gas forming pressure within sealed chambers 24, 122, or 124 is generally increasing throughout the forming process, but at fluctuating or oscillating rates of increase. A gas “pressure incline” followed by a pressure “hold” may be referred to as a pressure fluctuation cycle.

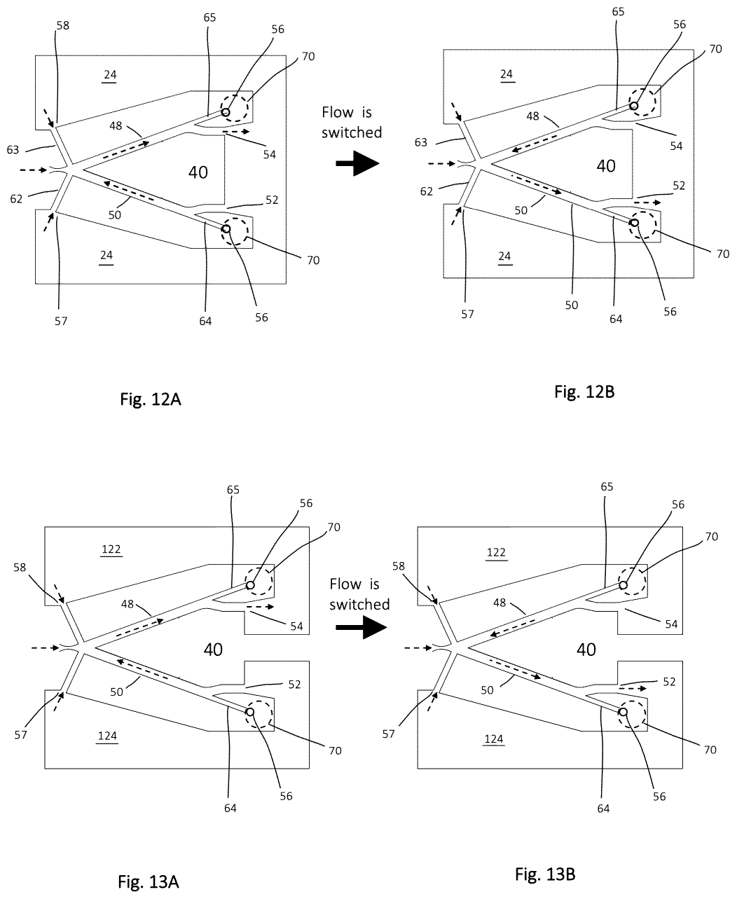

The flow switching aspect of bi-stable supersonic fluidic oscillator (SFO) 40 is demonstrated schematically in FIGS. 11 through 14. FIGS. 12, 13, and 14 shown how SFO 40 can be attached to a single or to dual chambers. As will be understood by one skilled in the art, the geometrical scalable design of the internal gas flow channels within the SFO 40, the size or scale of the SFO used, and/or the size of the feed back tanks attached to the SFO, can be customized according to the shape and volume of the associated sealed chamber(s) in order to maintain desired pressure fluctuation cycles. As such, depending on the geometrical design of the internal gas flow channels within the SFO, the size of the SFO, and/or the size of the feed back tanks attached to the SFO, the pressure controller, the gas pressure sensor, and the injection pressure sensor can operate to maintain certain conditions within the SFO so that pressure fluctuations are maintained while the baseline pressure is simultaneously increased.

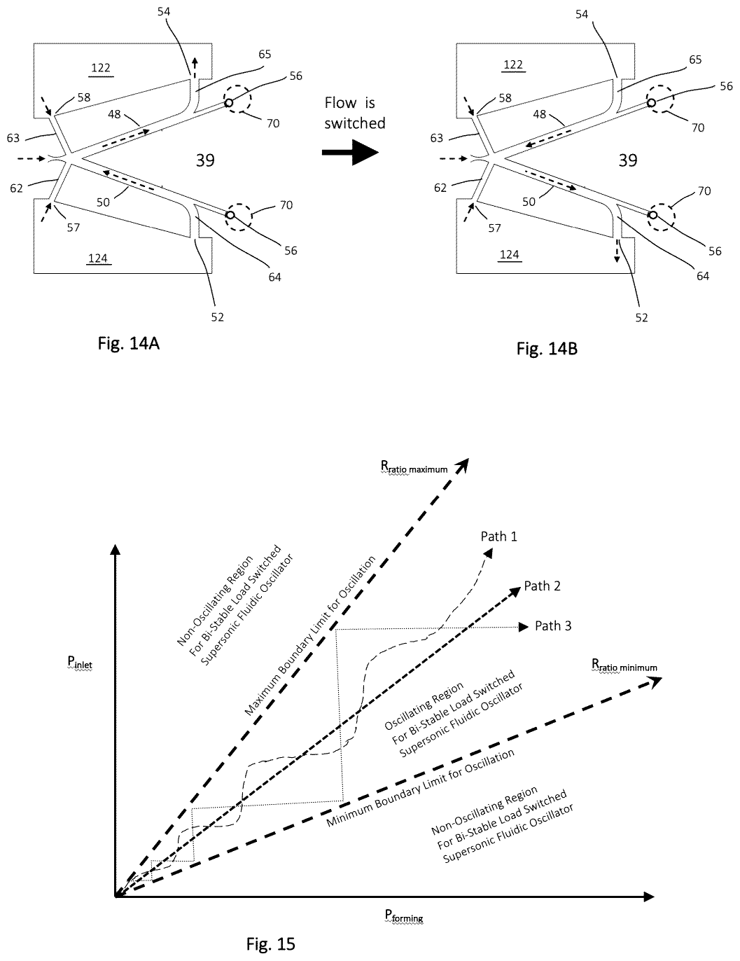

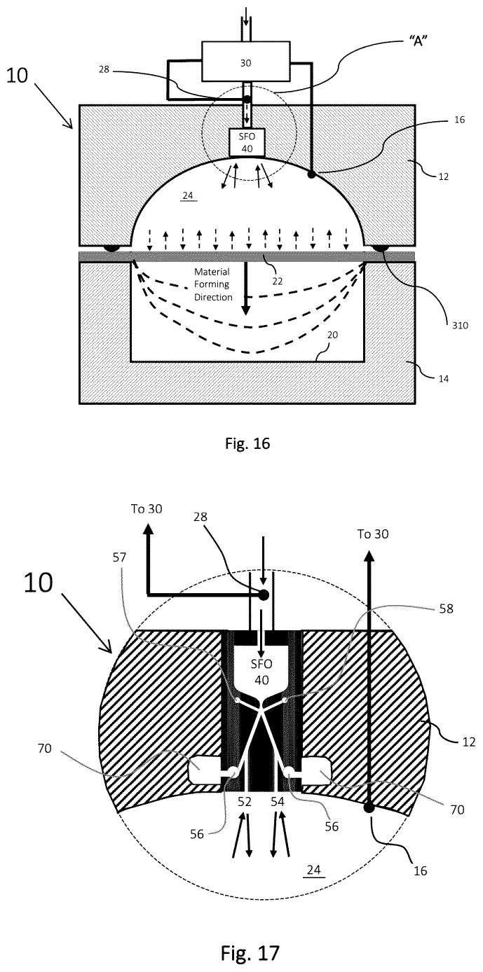

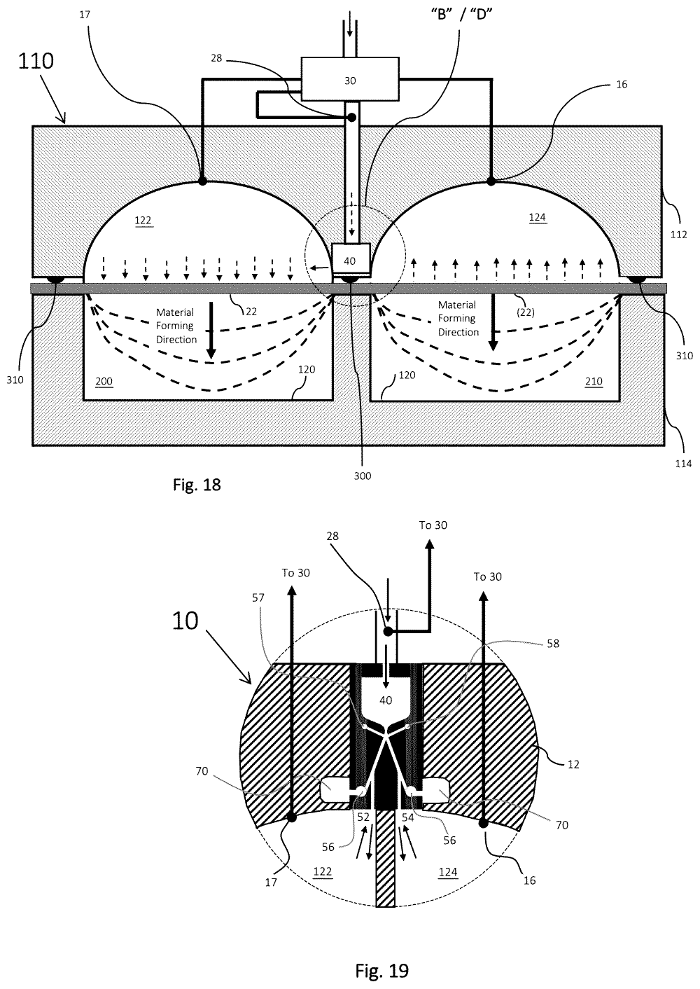

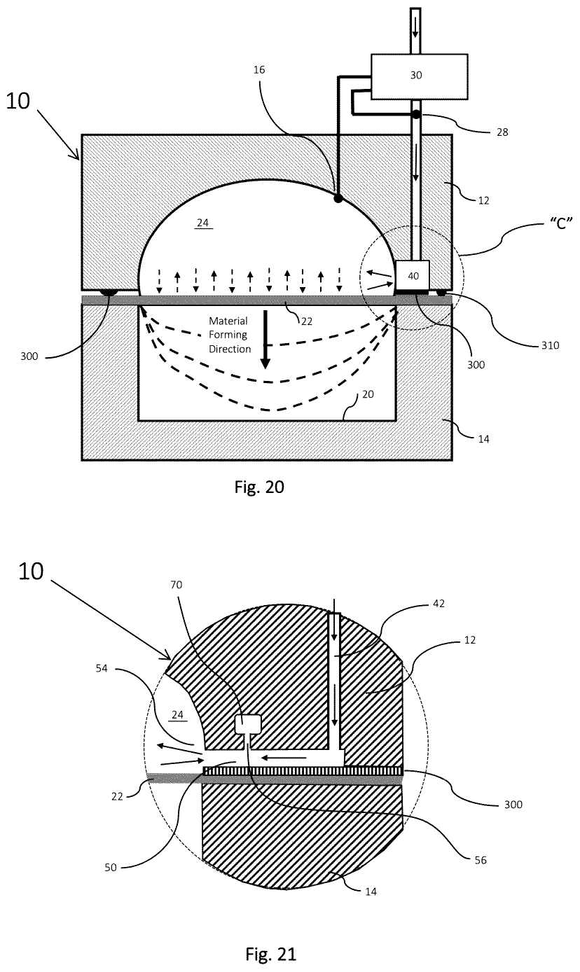

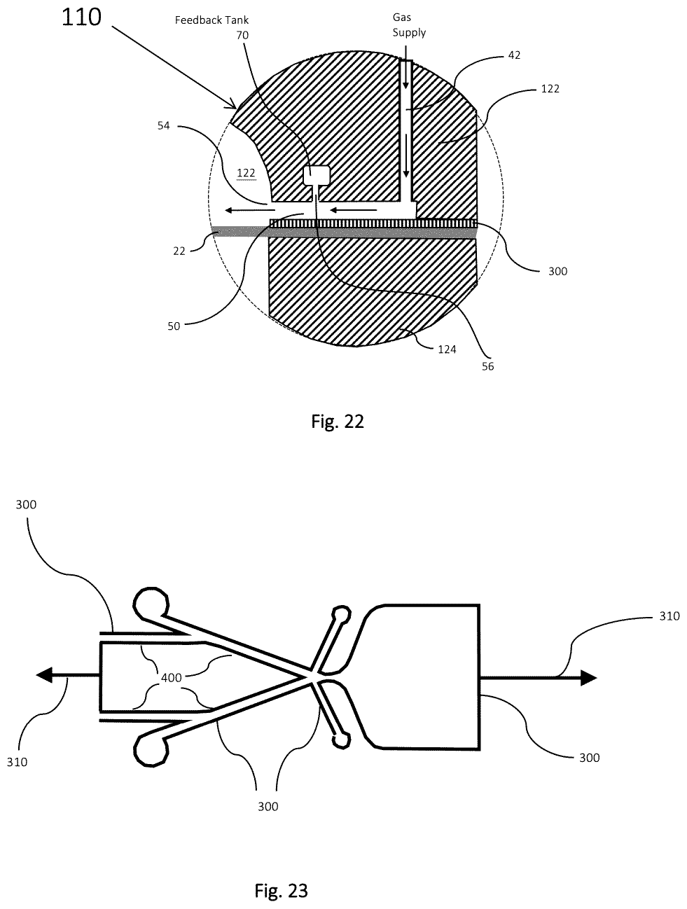

The applicant has found that a relationship exists between the gas pressure at inlet 42 of the SFO (referred to as Pᵢₙₗₑₜ) and the forming gas pressure (referred to as P_{Forming}) for a bi-stable supersonic fluid oscillator. It has been found that maintaining the ratio (Pᵣₐₜᵢₒ) Of Pᵢₙₗₑₜ/P_{Forming} within a defined range allows the bi-stable supersonic fluidic oscillator to generate continuous uninterrupted gas oscillations of various amplitudes and frequencies within sealed chambers 24, 122, 124 during the superplastic blow forming process. FIG. 15 illustrates a graph of Pᵢₙₗₑₜ VS P_{Forming}, showing a maximum and a minimum ratio (R_{Ratio} maximum and R_{Ratio} minimum, respectively) between which the bi-stable supersonic fluidic oscillator will generate continuous uninterrupted gas oscillations. A ratio above the maximum boundary limit or below the minimum boundary limit demonstrated by the dashed lines in FIG. 15 will result in a ceasing of oscillation or inconsistent and interrupted oscillation. The applicant has also determined that a graph similar to that illustrated in FIG. 15 can be created for similar geometrical shaped SFO's following routine testing or calibration of the SFO, and that such a graph can be used to control the operation of the superplastic forming process for a particular application.

It has therefore been determined that regulating the gas supply pressure Pᵢₙₗₑₜ provided to the bi-stable load switched supersonic fluidic oscillator 40 to achieve a desired gas pressure ratio Rᵣₐₜᵢₒ Of Pᵢₙₗₑₜ (measured with gas pressure sensor 28) vs P_{forming} (measured at gas pressure sensor 16,17) within a minimum and maximum boundary or range allows the bi-stable load switched supersonic fluidic oscillator to generate continuous, uninterrupted, gas oscillations within pressurized chamber 24, 122, 124 during a superplastic blow forming process.

Applying pressurized gas at a baseline pressure to a surface of the forming material, when the forming material is received within a cavity of a heated blow forming tool, while also maintaining Rᵣₐₜᵢₒ between R_{Ratio minimum} and R_{Ratio maximum} permits the generation of continuous gas oscillations, where each oscillation (i) deforms the material and (ii) subsequently allows for a partial stress relief of the material. FIG. 15 illustrates three examples of different Rᵣₐₜᵢₒ paths (labelled “Path 1”, “Path 2”, and “Path 3”) within the “oscillation region” that could be followed to permit the formation of continuous, uninterrupted, gas oscillations of various amplitudes and frequencies. It will be appreciated that the straight line of Path 2 represents the existence of constant frequency. Other possible Rᵣₐₜᵢₒ paths are possible.

Accordingly, control of the superplastic forming process may include programming a pressure controller 30 (or a PLC or other microprocessor control connected to pressure controller 30) to operate in a manner that maintains Rᵣₐₜᵢₒ between R_{Ratio minimum} and R_{Ratio maximum}, as determined from a plot similar to that shown in FIG. 15 and determined for the particular SFO and superplastic forming apparatus in question. Through the measurement of gas pressures with sensors 16,17 and sensor 28, controller 30 can determine Rᵣₐₜᵢₒ and make adjustments to the input pressure if needed to maintain Rᵣₐₜᵢₒ within its desired upper and lower boundaries at any point during the superplastic forming process (ie at any point along the plot of Pᵢₙₗₑₜ VS P_{Forming}). Further, controller 30 may be programmed or otherwise operated such that Rᵣₐₜᵢₒ follows a particular desired and predefined path (for example Path 1, Path 2, or Path 3 shown in FIG. 15) during the superplastic forming process. It is expected that in most cases it will be desirable to maintain a constant frequency of oscillations, to the extent that the precision of the components, and in particular controller 30, is capable of producing a constant frequency. In practice, small variations in straight line Path 2 are expected on account of manufacturing and operational limitations associated with controller 30.

Referring again to the use of superplastic forming apparatus 10, when a jet of gas exits the SFO outlets (as depicted by the longer solid arrow in FIGS. 4A and 4D), the pressure within sealed chamber 24 momentarily spikes, corresponding to pressure inclines “A” shown in FIGS. 9A, 9B, and 9C. When the jet of gas transitions between SFO outlets 52 and 54 (as depicted by the solid arrows in FIGS. 4B and 4C), the pressure within sealed chamber 24 is held relatively constant (i.e. drops slightly, increases slightly, or holds), corresponding to pressure holds “B” shown in FIGS. 9A, 9B, and 9C. As seen in FIGS. 9A, 9B, and 9C, during a pressure holds situation, the forming pressure may slightly fall below the baseline pressure.

Turning now to use of superplastic forming apparatus 110, when a jet of gas exits one of SFO outlets, as depicted by the longer solid arrow in FIG. 7A, the pressure within sealed chamber 124 momentarily spikes, corresponding to pressure inclines “A”, while the pressure within sealed chamber 122 momentarily is held relatively constant, corresponding to pressure holds “B” as shown in FIGS. 9A, 9B and 9C. When the jet of gas transitions to sealed chamber 122, as depicted by the longer solid arrow in FIG. 7B, the pressure within sealed chamber 122 momentarily spikes, corresponding to pressure inclines “A”, while the pressure within sealed chamber 124 is held relatively constant, corresponding to pressure holds “B” as shown in FIGS. 9A, 9B and 9C. As noted above, during the pressure holds “B” in any one of sealed chambers 122 or 124, the forming pressure may slightly fall below the baseline pressure.

While supersonic fluidic oscillators are specifically discussed, wherein the gas within the supersonic fluidic oscillator may reach supersonic speeds, it will be appreciated that other devices, including subsonic fluidic oscillators, could potentially be used to create the fluctuating pressure within sealed chambers 24 and 122, 124 of superplastic forming apparatus 10/110.

With reference to FIGS. 4A-4D, during operation of forming apparatus 10 the baseline gas pressure provides a constant source of forming gas pressure that is applied to material 22. Each pressure fluctuation resulting from the operation of SFO 40 will generally enhance (i.e. allow the material to deform at higher strain rates without tearing or fracturing, and to stretch or elongate with improved thickness uniformity) the deformation of material 22 when the forming pressure within sealed chamber 24 is increased beyond the baseline pressure, as depicted by the dashed arrows in FIGS. 4A and 4D. Each pressure cycle will also subsequently allow for a partial stress relief of material 22 when the gas forming pressure within sealed chamber 24 is generally held constant.

In a similar manner, during operation of forming apparatus 110 the gas baseline pressure provides a constant source of forming gas pressure that is applied to material 22 in both sealed chambers 112 and 124. Each pressure fluctuation resulting from the operation of SFO 40 will generally enhance the deformation of material 22 within sealed chamber 124 when the forming pressure within sealed chamber 124 is increased beyond the baseline pressure. This is depicted by the dashed arrows in sealed chamber 124 shown in FIG. 7A. At the same time, the gas forming pressure within sealed chamber 122 is held relatively constant, allowing for partial stress relief of material 22 in sealed chamber 122.

Each pressure fluctuation will subsequently allow the pressure between sealed chambers 122 and 124 to “alternate”. For example, when the forming pressure within sealed chamber 122 is increased beyond the baseline pressure, (as depicted by the dashed arrows in sealed chamber 122 shown in FIG. 7B) the rate of deformation of material 22 will tend to be enhanced. At the same time, the forming pressure within sealed chamber 124 will be held relatively constant, allowing for partial stress relief of material 22 in sealed chamber 124.

The applicant has found that in a particular embodiment of the invention, a pressure fluctuation frequency of 1-150 Hz can be achieved within sealed chambers 24 and 122, 124.

The applicant has also found that an amplitude of pressure fluctuation between approximately 0.01 psi and 1.0 psi can be achieved within sealed chambers 24 and 122, 124.

In one embodiment, the pressure fluctuations are continuous and of a uniform frequency throughout the forming process. In another embodiment, the pressure fluctuations are continuous and of both a uniform frequency and a uniform amplitude throughout the forming process. In other embodiments, the frequency and/or the amplitude of the pressure fluctuations may be discontinuous and/or varied during the forming process. One of ordinary skill will understand that in this context “uniform” does not necessarily mean precisely and exactly identical, and that relatively small variations are contemplated.

A further advantage of the particular embodiment depicted in the attached drawings is that through use of SFO 40, pressure fluctuations are created without the need for moving parts within the SFO. Given the relatively high temperatures at which the superplastic forming apparatus typically operates, moving parts may expand, warp and/or break-down during a forming cycle. SFO 40, on the other hand, does not use or require moving parts. SFO 40, thus does not have moving parts that can break down under high operating temperatures that can be experienced during a superplastic blow forming process. The frequency and amplitude characteristics of the gas exiting the SFO into the forming chamber 24 and 122, 124 will largely depend on the design of its internal geometry, the design of the feed back tanks, the design of output channels 48 and 50, the design of control channels 62 and 63 and ports 58, the inlet gas pressure to the SFO, and the gas pressure within chamber 24 and 122, 124. Varying one or more of these factors and/or design parameters permits a customization of the oscillator design for particular applications.

Various embodiments of a superplastic forming apparatus for use according to the present invention and for forming one or more parts are possible. Some of these possible embodiments are briefly described below.

In one particular variation of superplastic forming apparatus 10, the forming tool defines multiple sealed chambers which may be similar, nearly identical, or mirror one another in terms of shape and size. Each sealed chamber would typically also be operationally coupled to its own gas pressure sensor and SFO. The SFO's may then be, collectively, coupled to a single pressure controller. In this manner, the pressure controller would receive pressure signals from the multiple gas pressure sensors and control the gas pressure supply to the SFO's and injection of the gas that is simultaneously directed through the multiple gas oscillators into the multiple sealed chambers. This allows similar pressure-time profiles to be applied in each of the multiple sealed chambers such that multiple parts having a similar (or identical) shape and size may be formed at approximately the same time.

In further variation of superplastic forming apparatus 10, each cavity or sealed chamber within the forming tool may be different in terms of its shape and/or size. In such a case, each sealed chamber would typically be operationally coupled to its own gas pressure sensor, its own SFO, and its own pressure controller. In this manner, each pressure controller would receive pressure signals from its associated gas pressure sensors and control the pressure and injection of gas through its associated SFO into its associated sealed chamber. This allows different pressure-time profiles to be applied in each of the multiple, differently shaped and/or sized, sealed chambers such that multiple parts having different shapes and/or sizes may be formed at approximately the same time.

In a variation of superplastic forming apparatus 110, the forming tool may also define multiple pairs of sealed chambers which may be similar or nearly identical to other sealed chamber pairs in terms of shape and size. Each sealed chamber pair would typically also be operationally coupled to its own gas pressure sensors and SFO. The SFO's may then be, collectively, coupled to a single pressure controller. In this manner, the pressure controller would receive pressure signals from the multiple gas pressure sensors and control the pressure and injection of gas simultaneously directed through the multiple SFO's into the multiple pairs of sealed chambers. This allows similar pressure-time profiles to be applied in each of the multiple sealed chamber pairs such that multiple parts having a similar (or identical) shape and size may be formed at approximately the same time.

In another variation of superplastic forming apparatus 110, each pair of sealed chambers within the forming tool may be different from other sealed chamber pairs in terms of shape and/or size. In such a case, each sealed chamber pair would be operationally coupled to its own gas pressure sensors, its own SFO, and its own pressure controller. In this manner, each pressure controller would receive pressure signals from its associated gas pressure sensors and control the pressure and injection of gas through its associated SFO into its associated sealed chamber pair. This allows different pressure-time profiles to be applied in each of the multiple, differently shaped and/or sized, sealed chamber pairs such that multiple parts having different shapes and/or sizes may be formed at approximately the same time.

Different manners of constructing and fluidly connecting SFO 40 with superplastic forming apparatus 10,110 are contemplated. In an embodiment of the invention a bi-stable load switched supersonic fluidic oscillator ifs formed integrally with the superplastic forming apparatus itself. The bi-stable load switched supersonic fluidic oscillator may be (i) formed by machining channels or passageways (generally 400 in the attached drawings) into a pressing surface of the blow forming tool, (ii) formed by making channels or passageways in a separate component and welding or otherwise fixing or sealing the component to a pressing surface of the blow forming tool, (iii) manufactured through an additive manufacturing method (for example, 3D metal printed) and then welded or otherwise fixed or sealed to a pressing surface of the blow forming tool. In most instances it is expected that the channels or passageways 400 will have rectangular or generally rectangular cross-sections. The opposed sides and uppermost or back surfaces or boundaries of at least some of the passageways may be machined or formed within the pressing surface, or within a component fixed to the pressing surface. That is, the opposed sides and uppermost or back surfaces of the machined channels or passageways may effectively form an open trough-like structure, such that the lower or outermost boundaries of the channels or passageways are open to the atmosphere until the two portions of the blow forming tool are compressed against the sheet of material 22. At that point portions of the surface of the sheet of material 22 effectively become the lower or outermost surfaces or boundaries of the channels of the SFO, effectively enclosing the open trough-like structure, aside from openings at either end of each channel. In some instances particular passageways or structures (eg. feedback tanks 70) may be machined completely within the pressing surface of the blow forming tool. In some instances the channels or passageways may not be rectangular or generally rectangular in cross-section.

In an embodiment of the invention, the bi-stable load switched supersonic fluidic oscillator may be fully or partially machined directly into the blow forming tool with all of it geometrical shapes, including feedback tanks 70, situated within the forming tool. In another embodiment the SFO may be formed independently from the forming tool and later welded, glued, gasketed, or otherwise secured within a recessed machined or formed with the forming tool to achieve a gas tight seal between all of the SFO's flow passages and between the blow forming tool, except at exhaust flow ports 52 and 54 and control flow ports 57 and 58. In an yet a further embodiment the bi-stable load switched supersonic fluidic oscillator may be machined into the lower surface of the pressing surface of blow forming tool half or chamber portion 12. In this manner, and as described above, when chamber portion 12 is pressed against forming material 22 to create a gas tight seal between chamber portion 12 and tool portion 14, sections of the upper surface of material 22 will effectively act as the lower or outermost boundary or surface of the SFO, thereby creating a functioning bi-stable load switched supersonic fluidic oscillator. A sealing bead 300 may be machined or otherwise formed along the edges of the flow channels or passageways of the portion of the SFO that is machined into the pressing surface of chamber portion 12 to better bind under pressure against forming material 22, and to help create an integral and gas sealed bi-stable load switched supersonic fluidic oscillator. Similarly, beads or ridges 310 may be machined or otherwise formed around the perimeter of the pressing surface of chamber portion 12 to help to create a gas tight seal around the pressurized chamber of the blow forming tool. In this fashion forming material 22 effectively acts as a sealing gasket for the SFO when chamber portion 12 is pressed against tool portion 14. In an alternate embodiment, the SFO may be machined into the upper surface of the lower tool portion of the blow forming tool.

A supersonic fluidic oscillator formed in the above manner provides a number of advantages including (i) as it is essentially machined into the forming tool it will have the same thermodynamic characteristics and will expand and contract consistently with the forming tool, (ii) manufacturing the SFO will be simplified as intricate internal passageways will not need to be machined as the machining will be on the exterior of the chamber portion of the forming tool, and (iii) cleaning the passageways of the SFO will be easier and simpler as they will be more readily accessible when the two halves of the forming tool are separated.

It is to be understood that what has been described are the preferred embodiments of the invention. The scope of the claims should not be limited by the preferred embodiments set forth above, but should be given the broadest interpretation consistent with the description as a whole.

1. A method of controlling a superplastic forming process wherein a sheet of material is subjected to superplastic forming while retained within a chamber of a superplastic forming apparatus having a supersonic fluidic oscillator (SFO) in communication therewith, the method comprising:
determining a maximum limit and a minimum limit for a ratio of a supply pressure applied to the SFO related to a forming pressure within the chamber of the superplastic forming apparatus, wherein the application of supply pressure to the SFO in a manner that maintains the ratio between the maximum limit and the minimum limit causes the SFO to generate continuous, uninterrupted, gas oscillations,
with a supply pressure sensor, detecting the gas a pressure of gas supplied to the SFO and transmitting the detected supply pressure to a pressure controller,
with a forming pressure sensor, detecting the forming pressure within the chamber and transmitting the detected forming pressure to the pressure controller, and
operating the pressure controller to maintain the gas-pressure of gas supplied to the SFO in a manner that maintains the ratio of the detected supply-pressure of gas supplied to the SFO to the detected forming pressure between the maximum limit and the minimum limit.

2. The method as claimed in claim 1 wherein a series of ratios of detected pressure of gas supplied to the SEQ to detected forming pressure for increasing degrees of forming pressure, and that lie between the maximum limit and the minimum limit, are predetermined, the method further comprising operating the pressure controller to achieve the predetermined ratios during the superplastic forming process.

3. The method as claimed in claim 2 wherein the superplastic forming apparatus is a single chamber apparatus having a forming pressure sensor detecting the forming pressure within the single chamber and transmitting the detected forming pressure to the pressure controller.

4. The method as claimed in claim 2 wherein the superplastic forming apparatus is a dual chamber apparatus having two forming chambers, each forming chamber having its own dedicated forming pressure sensor, the method comprising detecting the forming pressure within each pressure chamber and transmitting the detected forming pressures to the pressure controller.

5. The method as claimed in claim 1 wherein the ratio of the detected pressure of gas supplied to the SFO to the detected forming pressure is maintained constant, resulting in a constant frequency of oscillation of the SFO.

6. The method as claimed in claim 1 wherein the ratio of the detected pressure of gas supplied to the SFO to the detected forming pressure is progressively adjusted, resulting in constant amplitude or desired amplitude and frequency of oscillation of the SFO.

7. A method of forming a supersonic fluidic oscillator (SFO), the method comprising:
(i) forming channels on a pressing surface of one of a chamber portion and a tool portion of a blow forming tool, the channels representing at least some of the flow channels of the SFO, the channels having lower or outermost boundaries that are open to the atmosphere,
(ii) placing a sheet of material to be formed by a superplastic forming process between the chamber portion and the tool portion of the blow forming tool, and
(iii) compressing the chamber portion and the tool portion against opposite sides of the sheet of material, thereby enclosing the lower or outermost boundaries of the channels and forming the SFO between the one of a chamber portion and a tool portion and the respective side of the sheet of material adjacent thereto.

8. The method as claimed in claim 7 further comprising forming sealing beads or ridges about edges of the channels, such that when the chamber portion and the tool portion are compressed against opposite sides of the sheet of material the sealing beads are compressed into the sheet of material to form a fluid tight seal along the edges of the channels.

9. The method as claimed in claim 7 wherein the channels are formed through machining passageways into the pressing surface of one of the chamber portion and the tool portion.

10. The method as claimed in claim 7 wherein the channels are formed through machining passageways into a separate component and fixing or sealing the separate component to a pressing surface of one of the chamber portion and the tool portion.

11. A supersonic fluidic oscillator (SFO) for use in a superplastic forming process wherein a sheet of material is subjected to superplastic forming while retained between pressing surfaces of a chamber portion and a tool portion of a blow forming tool, the SFO compromising:
a series of channels machined into the pressing surface of one of the chamber portion and the tool portion, the channels comprising an open trough-like structure within the respective chamber portion or tool portion,
wherein the channels have outermost boundaries that are defined by surfaces on the sheet of material when the sheet of material is placed between the pressing surfaces of the chamber portion and the tool portion, and when the chamber portion and the tool portions are compressed against opposite sides of the sheet of material.

12. The supersonic fluidic oscillator as claimed in claim 11 wherein the channels machined into the pressing surface of the respective chamber portion and the tool portion are generally rectangular in cross-section with opposed sides and a connecting back surface machined into the pressing surface of the respective chamber portion and tool portion.

13. The supersonic fluidic oscillator as claimed in claim 11 comprising sealing beads formed along the edges of the channels on the pressing surface of the one of a chamber portion and a tool portion, wherein the sealing beads are compressed into the sheet of material when the chamber portion and the tool portion are compressed about the sheet of material, the sealing beads assisting in the formation of a fluid tight seal along the edges of the channels.
